(19) United States
(12) Patent Application Publication
(10) Pub. No.: US 2025/0315232 A1
(43) Pub. Date: Oct. 9, 2025

(54) ONLINE CODE COMPILATION

(71) Applicant: International Business Machines Corporation, Armonk, NY (US)

(72) Inventors: Omkar Basavraj Ajagunde, Pune (IN); BharatBhushan Purohit, Pune (IN); Prem Prakash5, PUNE (IN)

(21) Appl. No.: 18/628,891

(22) Filed: Apr. 8, 2024

(51) Int. Cl. G06F 8/41; G06F 8/51

(52) U.S. Cl. CPC G06F 8/447; G06F 8/51

(57) ABSTRACT

Embodiments of the invention are directed to providing code compilation. Aspects include receiving, via a web browser, a source code in a first computing language from a user, converting the source code to a JavaScript, and creating a mapping between the source code and the JavaScript. Aspects also include executing the JavaScript and based on an error occurring during the execution of the JavaScript, identifying via the mapping a portion of the source code corresponding to the error and transmitting a notification to the user, the notification including the portion of the source code.

### BACKGROUND

The present invention relates in general to compiling source code, and more specifically, to computing systems, computer-implemented methods, and computer program products for providing an online compilation of source code.

Software development kits (SDKs) are software tools that are used to compile, execute, and debug software source code. In many cases, programmers, and students, especially find it challenging to install and run SDKs on their computer systems. As a result, online program compilers became popular because the online compilers allow users to compile, execute, and debug software source code without the hassle of installing any SDKs on their local computer system.

While online program compilers are convenient and easy to use for end-users (i.e., people writing and testing source code), existing online program compilers are computationally intensive, in part because the online program compilers need to maintain multiple virtual machines in memory that are each configured to execute different types of source code. In addition, if the online program compiler does not include a proper sandbox environment for the execution of the user's software code, there's a risk of user programs injecting malicious code into the server.

### SUMMARY

Embodiments of the invention provide a computer-implemented method for providing code compilation. The method includes receiving, via a web browser, source code in a first computing language from a user, converting the source code to a JavaScript, and creating a mapping between the source code and the JavaScript. The method also includes executing the JavaScript and based on an error occurring during the execution of the JavaScript, identifying via the mapping a portion of the source code corresponding to the error and transmitting a notification to the user, the notification including the portion of the source code.

Embodiments of the invention also provide computer-implemented methods and/or computer program products having substantially the same features as the computer system described above.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts details of an exemplary computing environment operable to implement various aspects of the invention.

FIG. 2 depicts a block diagram illustrating a web browser configured to perform online code compilation according to embodiments of the invention;

FIG. 3 depicts a user interface of a web browser configured to perform online code compilation according to embodiments of the invention;

FIG. 4 depicts a JavaScript code generated by an online code compiler according to embodiments of the invention;

FIG. 5 depicts a mapping between a source code and a JavaScript created by an online code compiler according to embodiments of the invention; and

FIG. 6 depicts a flowchart diagram of a method for performing online code compilation according to embodiments of the invention.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

As described above, while online program compilers are convenient and easy to use for end-users, existing online program compilers are computationally intensive and need to maintain multiple virtual machines in memory that are each configured to execute different types of source code. Accordingly, an online program compiler is needed that is convenient for end-users and that is not as computationally intensive as existing online program compilers.

Embodiments include methods, systems, and computer program products for online compilation of source code. In exemplary embodiments, the online program compiler is configured as a website that includes a user interface for a user to input a source code from a user in a first programming language to be compiled and executed. When the website is loaded onto a web browser (i.e., Mozilla Firefox, Google Chrome, etc.) of the user device, several modules, or JavaScript libraries, are loaded as the part of the website through same origin (domain) or through remote server where the JavaScript libraries are hosted. These modules include a source-to-source compiler module, a code execution module, an error mapper module, and an output translation module.

In exemplary embodiments, after a user has provided source code for compilation the source-to-source compiler module is configured to convert the provided source code to a JavaScript, which the web browser is configured to execute. In addition, the source-to-source compiler module creates a mapping between the user provided source code and the JavaScript. The JavaScript is then executed by the code execution module of the web browser. The code execution module of the web browser may be an embedded JavaScript execution engine such as SpiderMonkey, Chakra, V8 Engine, or the like.

If the JavaScript executes without encountering an error, the output translation module converts the JavaScript output back into an output format associated with the programming language of the source code, and the translated output is provided to the user. However, if an error is encountered during the execution of the JavaScript, the error mapper module identifies a portion of the user provided source code that corresponds to the error and provides a notification of the error and the portion of the user provided source code that corresponds to the error to the user. The disclosed online code compilation methods offload the computational work of compiling and executing the source code from the server to the user's machine, thereby significantly reducing the computational load on the server.

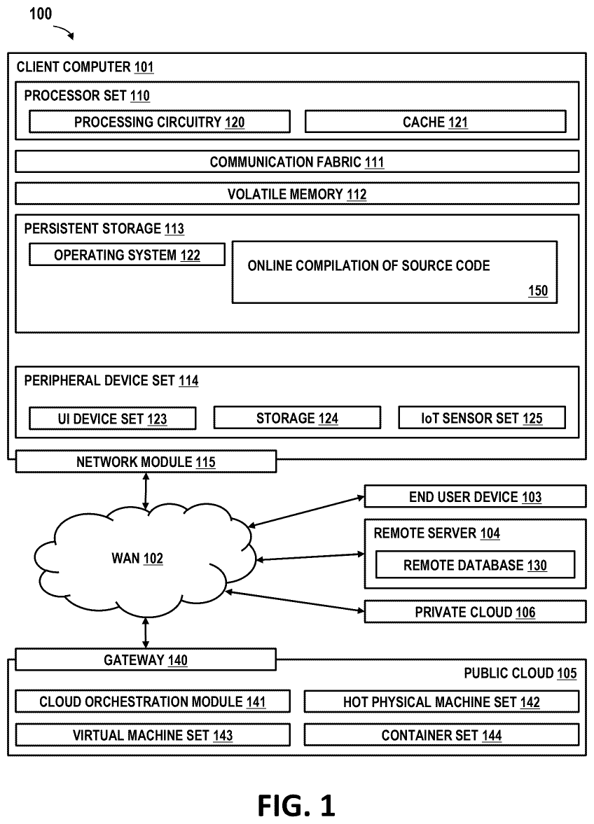

FIG. 1 depicts an example computing environment 100 that can be used to implement aspects of the invention. Computing environment 100 contains an example of an environment for the execution of at least some of the computer code involved in performing the inventive methods, such as online code compilation, as shown at block 150. In addition to block 150, computing environment 100 includes, for example, computer 101, wide area network (WAN) 102, end-user device (EUD) 103, remote server 104, public cloud 105, and private cloud 106. In this embodiment, computer 101 includes processor set 11 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 11 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 11. Cache memories are typically organized into multiple levels depending upon relative proximity to the processing circuitry. Alternatively, some, or all, of the cache for the processor set may be located “off chip.” In some computing environments, processor set 11 may be designed for working with qubits and performing quantum computing.

Computer readable program instructions are typically loaded onto computer 101 to cause a series of operational steps to be performed by processor set 11 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 11 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

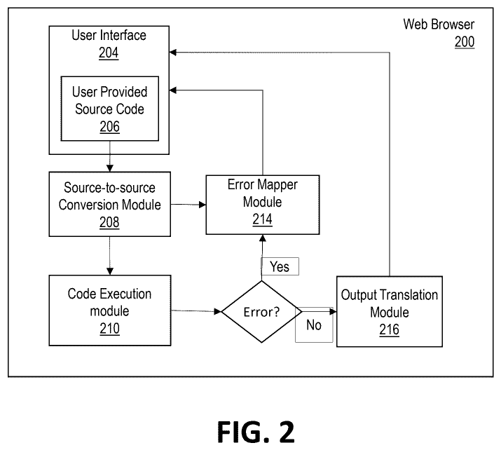

Turning now to a more detailed description of the aspects of the invention, FIG. 2 depicts a block diagram illustrating a web browser 200 configured to perform online code compilation according to embodiments of the invention. In exemplary embodiments, when the web browser 200 loads a code compilation website several modules, such as JavaScript libraries, may be loaded into the web browser 200. These libraries can be hosted on the same website or on a remote server. The libraries are then included in the website's HTML page using a script tag. This way, the website has all the necessary JavaScript scripts for source-to-source compilation, error mapping, code execution, and other functions. Alternatively, one or more of the depicted modules may be provided as part of the web browser 200. These modules include a source-to-source conversion module 208, a code execution module 210, an error mapper module 214, and an output translation module 216.

In exemplary embodiments, the web browser 200 includes a user interface 204 that is configured to receive a user provided source code 206. The user provided source code 206 is provided in a first programming language, such as Java, Python, Dart, C#, Scala, or Kotlin. In exemplary embodiments, once the user provided source code 206 has been received, the user provided source code 206 is provided to the source-to-source conversion module 208, which is configured to translate or convert the user provided source code 206 into a JavaScript. In addition, the source-to-source conversion module 208 is configured to create a mapping between the created JavaScript and the user provided source code 206. In one embodiment, the mapping includes a line-to-line correspondence between the JavaScript and the user provided source code 206.

After the JavaScript has been created from the user provided source code 206, the JavaScript is provided to the code execution module 210, which executes the JavaScript. In exemplary embodiments, the code execution module 210 of the web browser 200 may be an embedded JavaScript execution engine such as SpiderMonkey, Chakra, V8 Engine, or the like. Once the JavaScript has been executed, it is determined whether an error occurred during the execution. If an error occurs during the execution of the JavaScript, the error mapper module 214 is configured to identity a location in the user provided source code 206 and to display an error notification via the user interface 204. The error notification includes the location of the error in the user provided source code 206 and may also include an indication of the type of the error that occurred. In exemplary embodiments, the error mapper module 214 receives an identification of a line of the JavaScript that corresponds to the error and utilizes the mapping between the created JavaScript and the user provided source code 206 to determine the location in the user provided source code 206 that corresponds to the error.

In exemplary embodiments, if no error occurred during the execution of the JavaScript, the output translation module 214 is configured to translate or convert the output of the JavaScript into an output format corresponding to the first computing language, i.e., the computing language of the user provided source code 206. The output translation module 214 is further configured to display, via the user interface 204, the converted output.

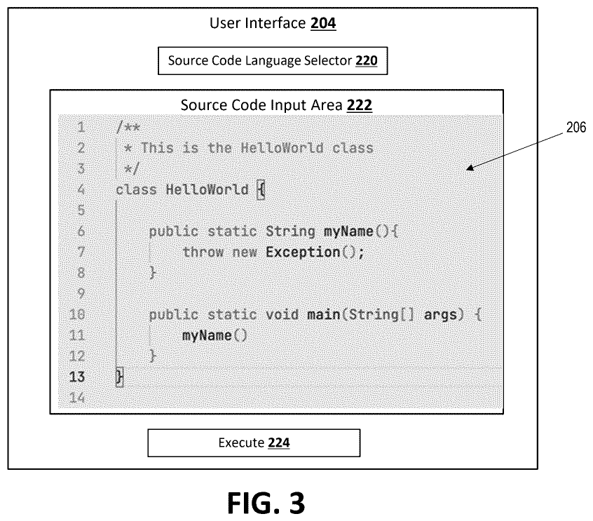

Referring now to FIG. 3, a user interface 204 of a web browser configured to perform online code compilation according to embodiments of the invention is shown. The user interface 204 includes a source code input area 222 in which a user is able to input a user provided source code 206. In exemplary embodiments, the user interface 204 also includes a source code language selector 220 that is configured to receive a user provided identification of the programing language associated with the user provided source code 206. In one embodiment, the source code language selector 220 is a drop-down menu that includes a list of programming languages that the source-to-source conversion module 208 is configured to convert into JavaScript. The user interface 204 also includes an icon 224 that is configured to initiate the complication and execution of the user provided source code 206. In exemplary embodiments, the user interface 204 is further configured to display one or more of an output of the execution of the user provided source code 206 and an error notification associated with the execution of the user provided source code 206.

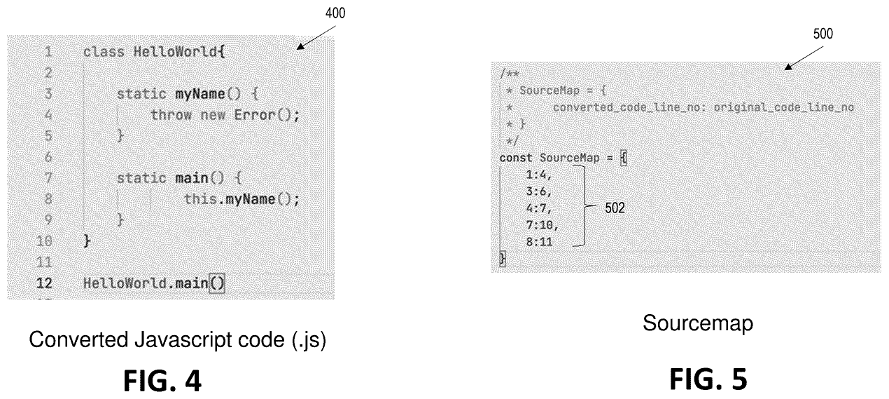

Referring now to FIGS. 4 and 5, a JavaScript 400 and a mapping 500 generated by the source-to-source conversion module 208 of the online code compiler according to embodiments of the invention is shown. In exemplary embodiments, the source-to-source conversion module 208 receives the user provided source code 206, which in the illustrated example is written in JAVA and generates JavaScript 400 and the mapping 500. All programming languages have their own syntax, but the basic operations are similar. For example, to throw an error in Java, we use ‘throw new Exception( )’, while in JavaScript, we use ‘throw new Error( )’. These are different syntaxes but have the same meaning. To convert code from one language to another, like Java to JavaScript, a step-by-step approach is followed. The step-by-step approach includes parsing the original code line by line and replacing Java syntax and keywords with their JavaScript equivalent literals and keywords. This process continues until the entire file is converted, resulting in the equivalent JavaScript code.

The mapping 500 includes a line-to-line correspondence 502 between the JavaScript 400 and the user provided source code 206. For example, line 1 of the JavaScript 400 corresponds to line 4 of the user provided source code 206. In one embodiment, the source-to-source conversion module 208 generates the line-to-line correspondence 502 of the mapping 500 as each line of the user provided source code 206 is converted to JavaScript 400. In another embodiment, the source-to-source conversion module 208 generates the line-to-line correspondence 502 of the mapping 500 after the user provided source code 206 is converted to JavaScript 400 by performing a comparison between the user provided source code 206 is converted to JavaScript 400.

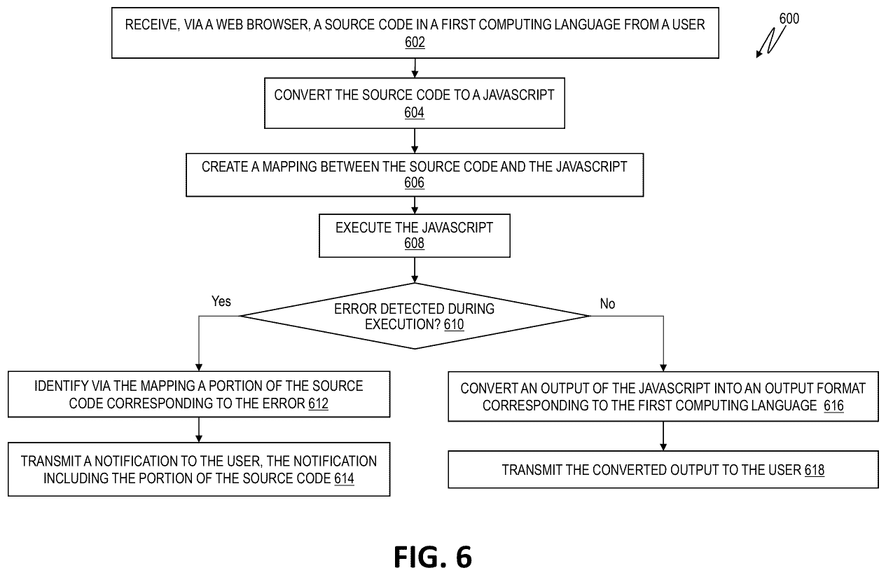

Referring now to FIG. 6, a flowchart diagram of a method for performing online code compilation according to embodiments of the invention. In exemplary embodiments, the method 600 is performed by a computing environment 100, such as the one shown in FIG. 1.

At block 602, the method 600 includes receiving, via a web browser, a source code in a first computing language from a user. In exemplary embodiments, the first computing language is one of Java, Python, Dart, C#, Scala, and Kotlin. In one embodiment, the source code is received with an indication of the first computing language from the user. Next, as shown at block 604, the method 600 includes converting the source code to a JavaScript. In exemplary embodiments, the source code is converted to a JavaScript by a source-to-source conversion module that is loaded into the web browser.

The method 600 also includes creating a mapping between the source code and the JavaScript, as shown at block 606. In one embodiment, the mapping includes a line-to-line correspondence between the user provided source code and the JavaScript. In exemplary embodiments, the mapping is created by a source-to-source conversion module that is loaded into the web browser. Next, as shown at block 606, the method 600 includes executing the JavaScript. In one embodiment, the JavaScript is executed by a code execution module of the web browser, such as an embedded JavaScript execution engine such as SpiderMonkey, Chakra, V8 Engine, or the like.

At decision block 610, the method 600 includes determining whether an error occurred during the execution of the JavaScript. If an error occurred during the execution of the JavaScript, the method 600 proceeds to block 610 and the method 600 includes identifying via the mapping a portion of the source code corresponding to the error. Next, at block 614 the method 600 includes transmitting a notification to the user, the notification including the portion of the source code. In exemplary embodiments, the notification further includes an identification of a type of the error that occurred.

If no error occurred during the execution of the JavaScript, the method 600 proceeds to block 616 and the method 600 includes converting an output of the JavaScript into an output format corresponding to the first computing language. Next, at block 618 the method 600 includes transmitting the converted output to the user.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” and variations thereof are used herein to mean “serving as an example, instance or illustration.” Any embodiment or design described herein as “exemplary” is not necessarily to be construed as preferred or advantageous over other embodiments or designs. The terms “at least one,” “one or more,” and variations thereof, can include any integer number greater than or equal to one, i.e. one, two, three, four, etc. The terms “a plurality” and variations thereof can include any integer number greater than or equal to two, i.e., two, three, four, five, etc. The term “connection” and variations thereof can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The phrases “in signal communication”, “in communication with,” “communicatively coupled to,” “electronically coupled to” and variations thereof can be used interchangeably herein and can refer to any coupling, connection, or interaction using electrical signals to exchange information or data, using any system, hardware, software, protocol, or format, regardless of whether the exchange occurs wirelessly or over a wired connection.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It will be understood that those skilled in the art, both now and in the future, may make various improvements and enhancements which fall within the scope of the claims which follow.

What is claimed is:

1. A computer-implemented method for providing code compilation comprising, the method comprising:
receiving, via a web browser, a source code in a first computing language from a user;
converting the source code to a JavaScript;
creating a mapping between the source code and the JavaScript;
executing the JavaScript; and
based on an error occurring during the execution of the JavaScript, identifying via the mapping a portion of the source code corresponding to the error and transmitting a notification to the user, the notification including the portion of the source code.

2. The computer-implemented method of claim 1, wherein the first computing language is one of Java, Python, Dart, C#, Scala, and Kotlin.

3. The computer-implemented method of claim 1, wherein the mapping between the source code and the JavaScript includes a correspondence between lines of the JavaScript and lines of the source code.

4. The computer-implemented method of claim 1, wherein the converting the source code to the JavaScript, the creating the mapping between the source code and the JavaScript, and the executing the JavaScript are performed by the web browser.

5. The computer-implemented method of claim 1, further comprising:
based on a successful execution of the JavaScript, converting an output of the JavaScript into an output format corresponding to the first computing language.

6. The computer-implemented method of claim 1, wherein the notification further includes a type of the error.

7. The computer-implemented method of claim 1, wherein the converting the source code to the JavaScript is performed by a source-to-source compiler embedded in a code of a website that is loaded in the web browser.

8. The computer-implemented method of claim 1, further comprising receiving, from the user via the web browser an identification of the first computing language.

9. A computer system comprising a processor electronically coupled to a memory, wherein the processor performs operations comprising:
receiving, via a web browser, a source code in a first computing language from a user;
converting the source code to a JavaScript;
creating a mapping between the source code and the JavaScript;
executing the JavaScript; and
based on an error occurring during the execution of the JavaScript, identifying via the mapping a portion of the source code corresponding to the error and transmitting a notification to the user, the notification including the portion of the source code.

10. The computer system of claim 9, wherein the first computing language is one of Java, Python, Dart, C#, Scala, and Kotlin.

11. The computer system of claim 9, wherein the mapping between the source code and the JavaScript includes a correspondence between lines of the JavaScript and lines of the source code.

12. The computer system of claim 9, wherein the converting the source code to the JavaScript, the creating the mapping between the source code and the JavaScript, and the executing the JavaScript are performed by the web browser.

13. The computer system of claim 9, wherein the operations further comprise:
based on a successful execution of the JavaScript, converting an output of the JavaScript into an output format corresponding to the first computing language.

14. The computer system of claim 9, wherein the notification further includes a type of the error.

15. The computer system of claim 9, wherein the converting the source code to the JavaScript is performed by a source-to-source compiler embedded in a code of a website that is loaded in the web browser.

16. The computer system of claim 9, wherein the operations further comprise receiving, from the user via the web browser an identification of the first computing language.

17. A computer program product comprising a computer readable program stored on a computer readable storage medium, wherein the computer readable program, when executed on a processor system, causes the processor system to perform operations comprising:
receiving, via a web browser, a source code in a first computing language from a user;
converting the source code to a JavaScript;
creating a mapping between the source code and the JavaScript;
executing the JavaScript; and
based on an error occurring during the execution of the JavaScript, identifying via the mapping a portion of the source code corresponding to the error and transmitting a notification to the user, the notification including the portion of the source code.

18. The computer program product of claim 17, wherein the mapping between the source code and the JavaScript includes a correspondence between lines of the JavaScript and lines of the source code.

19. The computer program product of claim 17, wherein the converting the source code to the JavaScript, the creating the mapping between the source code and the JavaScript, and the executing the JavaScript are performed by the web browser.

20. The computer program product of claim 17, wherein the operations further comprise:
based on a successful execution of the JavaScript, converting an output of the JavaScript into an output format corresponding to the first computing language.
